(19) United States
(12) Patent Application Publication
(10) Pub. No.: US 2016/0092553 A1
(43) Pub. Date: Mar. 31, 2016

(54) METHODS AND APPARATUSES OF GENERATING AND USING A STRUCTURED LABEL

(71) Applicant: Alibaba Group Holding Limited, Grand Cayman (KY)

(72) Inventor: Wei Liu, Hangzhou (CN)

(73) Assignee: Alibaba Group Holding Limited

(21) Appl. No.: 14/869,545

(22) Filed: Sep. 29, 2015

(30) Foreign Application Priority Data
Sep. 29, 2014 (CN) 201410515536.7

(51) Int. Cl. G06F 17/30

(52) U.S. Cl. CPC G06F 17/30598; G06F 17/30011

(57) ABSTRACT

Methods and apparatuses of generating and using a structured label are disclosed. The method of generating the structured label includes creating a structured labeling system; configuring at least one rule for each label in the structured labeling system, the rule used select one or more network objects from a plurality of network objects; and labeling the plurality of network objects according to the configured rule, wherein at least a portion of the plurality of network objects related to a topical search belong to different categories. The present disclosure provides a structured label for implementing navigation on a topical search in a search page.

### CROSS REFERENCE TO RELATED PATENT APPLICATION

This application claims foreign priority to Chinese Patent Application No. 201410515536.7 filed on Sep. 29, 2014, entitled “Methods and Apparatuses of Generating and Using a Structured Label”, which is hereby incorporated by reference in its entirety.

### TECHNICAL FIELD

The present disclosure relates to the field of Internet technology, and particularly, to methods and apparatuses of generating and using a structured label.

### BACKGROUND

Currently, an electronic commerce website typically employs category navigation and attribute navigation to provide navigation information to users. The category navigation is mostly represented using a tree structure. A user clicks content in the category navigation to narrow a search scope, and then uses the attribute navigation to accurately find a commodity desired by the user.

Searching for information of a certain field or subject is referred to as a topical search. For example, a topical search of outdoor climbing may cover a range of commodities that include a compass, a camping tent, a sport bottle, a flashlight, a touring jacket, a backpack, a folding chair, hiking shoes, sports gear, etc. These commodities belong to different categories, and the existing category system doesn't have a single parent category, which is able to cover all these categories to aggregate the commodities of these categories. If a search that is based on category navigation is a vertical search, a topical search is usually a horizontal search across multiple categories, and the category navigation does not work for the horizontal topical search. In other words, a topical search cannot provide navigation information in a search page in a form of category navigation.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or computer-readable instructions as permitted by the context above and throughout the present disclosure.

Aspects of the present disclosure provide methods and apparatuses of generating and using a structured label, which are used for providing a structured label and facilitating an implementation of navigation for a topical search in a search page.

In an implementation, a method of generating a structured label may include creating a structured labeling system that complies with requirements of a topical search, the structured labeling system including multiple levels of labels, each level containing at least one label; configuring, for each label in the structured labeling system, at least one rule used for describing a network object to which a respective label is able to attach based on data associated with network objects related to the topical search; mapping the rule of each label into the structured labeling system to obtain structured label data for use in labeling the network objects related to the topical search, wherein at least some of the network objects attached with labels of a same level belong to different categories.

In an implementation, a method of using a structured label may include obtaining a structured labeling system, the structured labeling system including multiple levels of labels and each level containing at least one label, wherein a respective rule of each label in the structured labeling system that describes a network object to which the respective label is able to attach is mapped into the structured labeling system to obtain structured label data; performing a search according to a search condition to obtain at least one target network object that meets the search condition, the search condition including at least one target label to be searched for and the target network object being a network object that is attached with any one target label of the at least one target label based on the structured label data, wherein at least a portion of target network objects attached with labels of a same level belong to different categories; conducting statistics for the at least one target network object to obtain a number of network objects under each target label of the at least one target label; and displaying the structured labeling system and the number of network objects under each target label in a navigation region of a search page based on a hierarchical structure of the structured labeling system.

In an implementation, an apparatus of generating a structured label may include a creation module to create a structured labeling system that complies with requirements of a topical search, the structured labeling system including multiple levels of labels and each level containing at least one label; a configuration module to configure, for each label in the structured labeling system, at least one rule used for describing a network object to which a respective label is able to attach based on data associated with network objects related to the topical search; and an acquisition module to map the rule of each label into the structured labeling system to obtain structured label data for use in labeling the network objects related to the topical search, wherein at least some of the network objects attached with labels of a same level belong to different categories.

In an implementation, an apparatus of using a structured label may include a first acquisition module to obtain a structured labeling system, the structured labeling system including multiple levels of labels and each level containing at least one label, wherein a respective rule of each label in the structured labeling system that describes a network object to which the respective label is able to attach is mapped into the structured labeling system to obtain the structured label data; a second acquisition module to perform a search according to a search condition to obtain at least one target network object that meets the search condition, the search condition including at least one target label to be searched for and the target network object being a network object that is attached with any one target label of the at least one target label based on the structured label data, wherein at least a part of target network objects attached with labels of a same level belong to different categories; a third acquisition module to conduct statistics for the at least one target network object to obtain a number of network objects under each target label of the at least one target label; and a first display module to display the structured labeling system and the number of network objects under each target label in a navigation region of a search page based on a hierarchical structure of the structured labeling system.

In an implementation, a server is provided. The server is configured to respond to an access request sent from a user via a client, enable the client to display a topical webpage interface. The topical webpage interface includes a search region, a network object display region, and a structured label display region. The search region is configured to receive a query inputted by the user. The network object display region is configured to display multiple network objects that match with the query. The structured label display region is configured to display at least one first-level label and at least one second-level label that is located under the first-level label. When at least one of the first-level label or the second-level label is selected by the user, a network object set that is displayable in the network object display region includes at least a first network object and a second network object. The first network object belongs to a first category, and the second network object belongs to a second category that is different from the first category.

The present disclosure creates a structured labeling system based on requirements of a topical search, configures at least one rule for describing a network object to which a respective label is able to attach for each label under each level in the structured labeling system, maps the rule configured for each label into the structured labeling system correspondingly to obtain structured label data for use in labeling network objects related to the topical search. In addition, the present disclosure performs a search according to a search condition to obtain target network object(s) that meet(s) the search condition, conducts statistics for a respective number of network objects under target label(s) included in the search condition, and displays the structured labeling system and the respective number of network objects under each target label in a navigation region of a search page according to a hierarchical structure of the structured labeling system, to provide navigation information. Since a label, rather than a single category rule, is used in the present disclosure, an inclusion relationship between cluster ranges to which network objects belong can be embodied via a hierarchical relationship between labels, and is no longer embodied by a single category. Moreover, network object(s) corresponding to each label can be determined by different rules. Therefore, network objects attached with labels of a same level may belong to different categories, which is different from the single category rule, thus being applicable to a topical search for network objects covering a plurality of categories and thereby providing navigation information for the topical search in a search page.

### DESCRIPTION OF THE DRAWINGS

In order to describe technical solutions in embodiments of the present disclosure more clearly, accompanying drawings used for describing the embodiments or existing technologies are briefly described herein. Apparently, the accompanying drawings merely represent some embodiments of the present disclosure. One of ordinary skill in the art may still derive other drawings from these accompanying drawings without making any creative effort.

FIG. 1 is a flowchart illustrating a method of generating a structured label according to an embodiment of the present disclosure.

FIG. 2 is a structural diagram illustrating a structured labeling system according to an embodiment of the present disclosure.

FIG. 3 is a flowchart illustrating a method of generating a structured label according to another embodiment of the present disclosure.

FIG. 4 is a flowchart illustrating a method of using a structured label according to an embodiment of the present disclosure.

FIG. 5 is a flowchart illustrating a method of using a structured label according to another embodiment of the present disclosure.

FIG. 6 is a structural diagram illustrating an apparatus of generating a structured label according to an embodiment of the present disclosure.

FIG. 7 is a structural diagram illustrating an apparatus of using a structured label according to an embodiment of the present disclosure.

### DETAILED DESCRIPTION

In order to make the objectives, technical solutions and advantages of the present disclosure more clear, the technical solutions in the embodiments of the present disclosure are described clearly and completely with reference to the accompanying drawings in the embodiments of the present disclosure. Apparently, the described embodiments merely represent a part of but not all of the embodiments of the present disclosure. Based on the embodiments in the present disclosure, all other embodiments derived by one of ordinary skill in the art without making any creative effort shall fall within the scope of protection of the present disclosure.

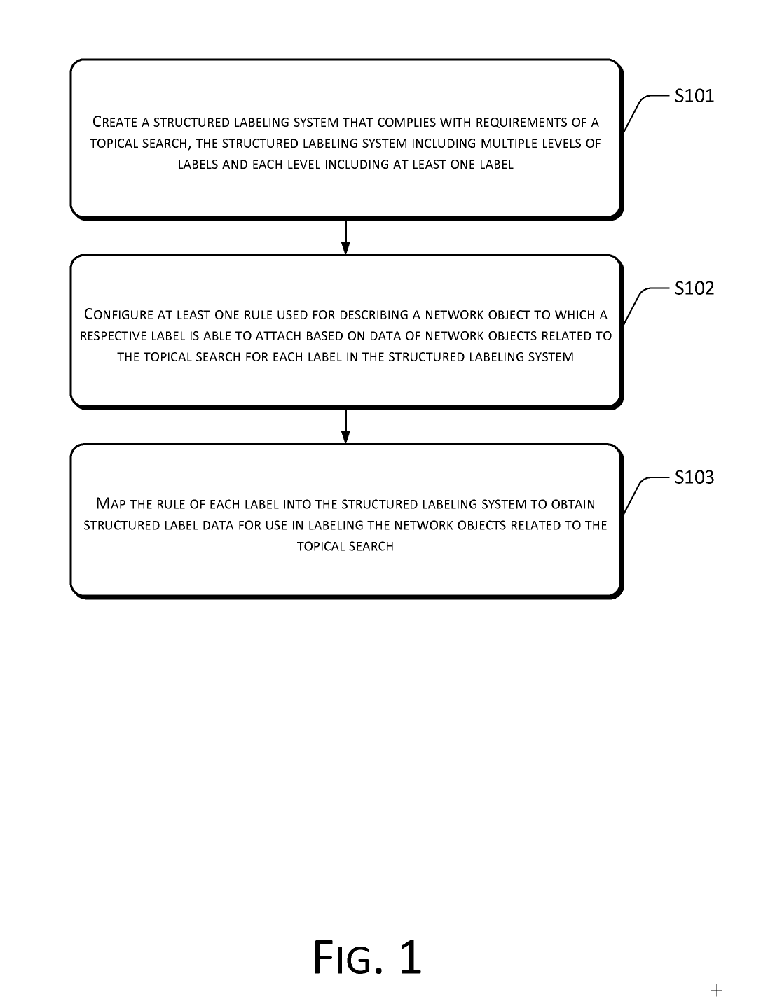

FIG. 1 is a flowchart illustrating a method of generating a structured label according to an embodiment of the present disclosure. The method may be implemented by a structured label generating apparatus, which is referred to as a generating apparatus. As shown in FIG. 1, the method may include:

S101 creates a structured labeling system that satisfies requirements of a topical search, the structured labeling system including multiple levels of labels and each level including at least one label.

The topical search in this embodiment refers to a search for information of a certain field or subject. A search result of this type of topical search generally falls within a range of network objects related to a single field or a single subject. In addition, a topical search is provided as a navigation area on a search page to provide navigation information based on a field or subject related to the topical search. Different topical searches have different requirements, and different topical searches are related to different fields or subjects. For example, for a wedding topical search, a search result thereof is usually restricted within a range of wedding-related network objects, and a desire thereof is to have a navigation block on a search page to be able to provide navigation information which includes wedding room decorations, envelopes and invitations, wedding dresses, wedding food, wedding jewelry, and wedding silverware, etc. In addition to the wedding topical search, topical searches may also include a topical search for outdoor climbing, a topical search for labor protection supplies, etc. Network objects may include, but are not limited to, commodities related to a corresponding topical search.

In an implementation, the generating apparatus first creates a structured labeling system that satisfies requirements of a topical search according to the requirements of the topical search. For example, according to different requirements of topical searches, numbers of levels associated with labels included in respective structured labeling systems may be different from one another. For instance, the generating apparatus may set up a first-level label, set up a plurality of second-level labels for the first-level label, set up a plurality of third-level labels for each second-level label of the plurality of second-level labels, and continue to perform setup accordingly in this way, thereby constructing a structured labeling system according to requirements of a certain topical search. In addition, according to requirements of different topical searches, the generating apparatus may set up a two-level labeling system, a four-level labeling system, etc. Each label has a name, and a label may be represented by a name of the label.

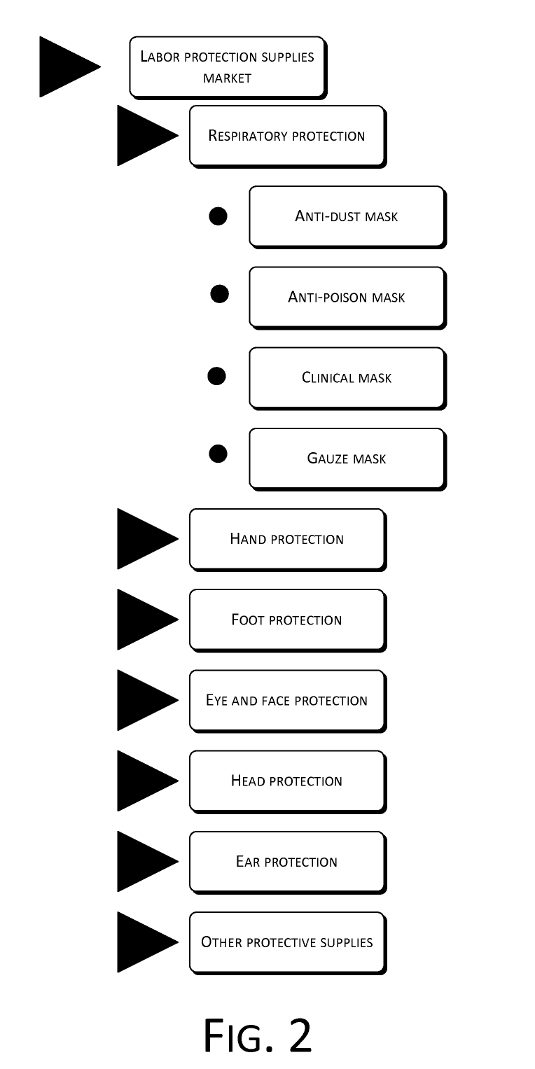

A topical search for worker protection supplies is used as an example. The generating apparatus creates a structured labeling system therefor as shown in FIG. 2. The structured labeling system includes three levels of labels. The first-level label includes a labor protection supplies market label. The second-level label includes a respiratory protection label, a hand protection label, a foot protection label, an eye and face protection label, a head protection label, an ear protection label, and labels of other protective supplies. Each second-level label includes a plurality of third-level labels. FIG. 2 merely shows third-level labels that are included in the respiratory protection label, which includes an anti-dust mask label, an anti-poison mask label, a clinical mask label and a gauze mask label.

S102 configures at least one rule used for describing a network object to which a respective label is able to attach based on data of network objects related to the topical search for each label in the structured labeling system.

A label is equivalent to a tag of a network object. Tags are merely used for performing a certain classification for all network objects. A label does not have any meaning on its own, and what is really meaningful is a set of rules corresponding to the label. A purpose of the set of rules is mainly to describe or restrict network object(s) that is/are able attached with the label, i.e., to which network object(s) the label is attachable can be determined through the rules corresponding to the label. A rule in this embodiment is a relatively broad concept. For example, “material of a network object contains polyester” may be a rule, “a level of a supplier of a network object is 3A or above” may also be a rule. Alternatively, “a category to which a network object belongs falls within a clothing category” may be a rule.

Based on the foregoing description, the generating apparatus may configure, for each label in the structured labeling system, at least one rule for describing a respective network object to which a label is able to attach after creating the structured labeling system. In an implementation, the generating apparatus may configure a rule for each label in the structured labeling system according to data that is associated with network objects related to the topical search.

The data that is associated with the network objects refers to various types of data related to all the network objects that are related to (or covered by) the topical search, which may include, for example, a price of a network object, a category to which the network object belongs, a provider of the network object, a provider level of the network object, a material of the network object, a payment method supported by the network object, a name of the network object, etc. Data of a certain network object may be only a portion of data in network object data. Network object data can be used to describe or restrict a network object. Therefore, the generating apparatus may set up at least one rule for each label based on network object data, so as to limit or describe network object(s) that is/are able to attach with the label through the set rule. In an implementation, rules for labels of different levels may be different, and rules for different labels of a same level may also be different. A hierarchical relationship between labels may embody an inclusion relationship between cluster ranges to which respective network objects that are attached with the labels belong. In addition, since different labels of a same level may correspond to different rules, network objects which are attached with different labels need to satisfy different rules. As such, network objects attached with labels of a same level may belong to different categories, which is different from conventional category navigation.

S103 maps the rule of each label into the structured labeling system to obtain structured label data for use in labeling the network objects related to the topical search.

After each label is configured with rule(s), the rule(s) for each label may be mapped into the structured labeling system. Specifically, the rule(s) for each label is/are mapped into a corresponding label in the structured labeling system to obtain structured label data. The structured label data may include label(s) and respective rule(s) for the label(s).

Based on the structured label data, the generating apparatus may attach labels for the network objects related to the topical search. Network objects attached with labels of a same level may belong to a same category or may belong to different categories. In an optional implementation, at least some network objects attached with labels of a same level belong to different categories. A process of attaching a label may be referenced to a description of an embodiment in the following.

This embodiment creates a structured labeling system based on requirements of a topical search, configures at least one rule for describing a network object to which a respective label is able to attach for each label under each level in the structured labeling system, maps the rule configured for each label into the structured labeling system correspondingly to obtain structured label data for use in labeling network objects related to the topical search. Since a label, rather than a single category rule, is used in the present disclosure, an inclusion relationship between cluster ranges to which network objects belong can be embodied via a hierarchical relationship between labels, and is no longer embodied by a single category. Moreover, network object(s) corresponding to each label can be determined by different rules. Therefore, network objects attached with labels of a same level may belong to different categories, which is different from the single category rule, thus being applicable to a topical search for network objects covering a plurality of categories and thereby providing navigation information for the topical search in a search page.

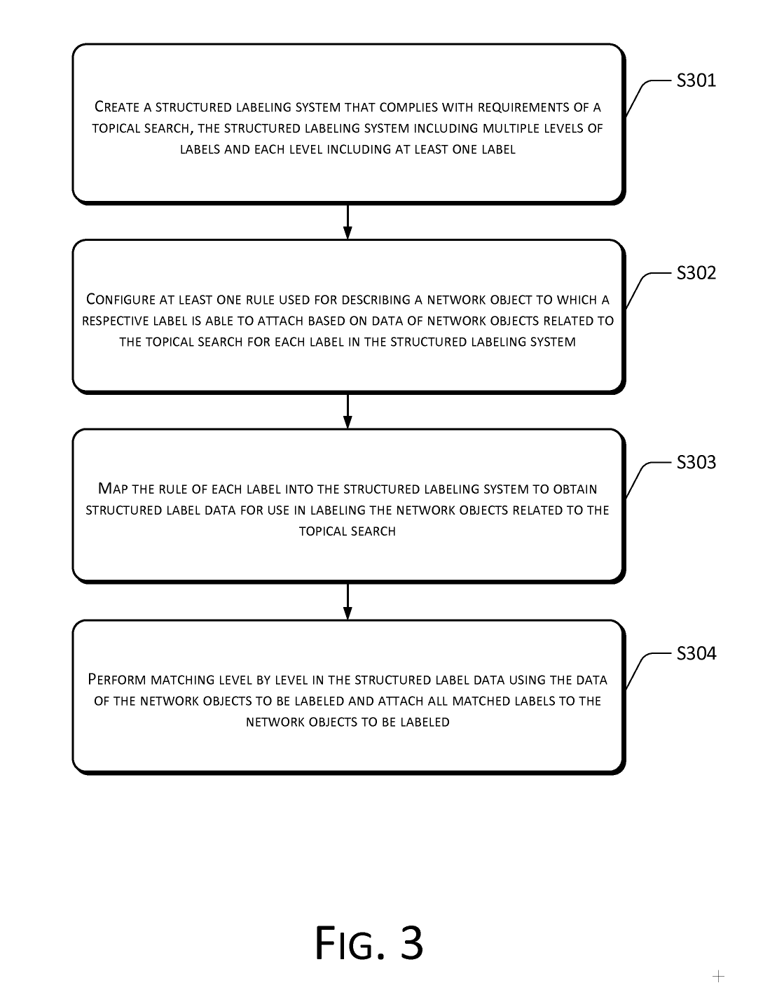

FIG. 3 is a flowchart illustrating a method of generating a structured label according to another embodiment of the present disclosure. As shown in FIG. 3, this embodiment may include:

S301 creates a structured labeling system that complies with requirements of a topical search, the structured labeling system including multiple levels of labels and each level containing at least one label.

S302 configures at least one rule used for describing a network object to which a respective label is able to attach based on data of network objects related to the topical search for each label in the structured labeling system.

S303 maps the rule of each label into the structured labeling system to obtain structured label data for use in labeling the network objects related to the topical search.

S304 performs matching level by level in the structured label data using the data of the network objects to be labeled and attaches all matched labels to the network objects to be labeled.

The method blocks S301-S303 in this embodiment can be referenced to correspond to the method blocks S101-S103 in the embodiment shown in FIG. 1, and are not repeatedly described herein.

Furthermore, after the structured label data is obtained, data of the network objects to be labeled may be used to perform matching level by level in the structured label data. In an implementation, matching is performed for the rules included in the structured label data one level after one level. A label corresponding to a rule that matches with data of a network object to be labeled is taken as a matched label, and the matched label is attached to the network object to be labeled.

In an implementation, for a network object to be labeled, data of the network object is obtained. Rule(s) of a first-level label in the structured label data is/are traversed to determine whether the data of the network object satisfies the rule(s) of the first-level label. If affirmative, the network object is attached with the first-level label. Otherwise, the network object is not attached with the first-level label. If the data of the network object satisfies the rule(s) of the first-level label, rule(s) of a second-level label in the structured label data is/are then traversed to determine whether the data of the network object satisfies the rule(s) of the second-level label. If affirmative, the network object is attached with the second-level label. Otherwise, the network object is not attached with the second-level label. If the data of the network object satisfies the rule(s) of the second-level label, rule(s) of a third-level label in the structured label data is/are subsequently traversed to determine whether the data of the network object satisfies the rule(s) of the third-level label. If affirmative, the network object is attached with the third-level label. Otherwise, the network object is not attached with the third-level label. The rest can be done in the same manner, until all the labels of the structured label data are traversed. In this way, if a network object satisfies rule(s) of a second-level label, the network object also satisfies rule(s) of a first-level label, i.e., the network object is attached with the first-level label and the second-level label at the same time. If a network object satisfies rule(s) of a third-level label, the network object also satisfies rule(s) of a second-level label and rule(s) of a first-level label, i.e., the network object is also attached with the second-level label and the first-level label at the same time. Similarly, if a network object satisfies rule(s) of a label of a certain level, the network object also satisfies respective rule(s) of all labels on a parent path of that label, and is attached with all the labels on the parent path at the same time.

It should be noted that the foregoing process of labeling is described from the perspective of a depth traversal. In addition, since each level may include a plurality of labels, i.e., a plurality of labels may exist in a same level, a description of a process of labeling from the perspective of a breadth traversal is needed. Therefore, a process of traversing each level of labels includes traversing all labels one by one under each level to determine whether data of a network object complies with rule(s) of a label that is currently traversed. If the data of the network object complies with the rule(s) of that label, the network object is attached with that label. In other words, for each label under a certain level, when a first label is traversed, a second label, a third label, and so on, of the same level also need to be traversed for the network object, until each label under that level is traversed. In other words, a network object may be attached with a plurality of labels of a same level at the same time.

One or more matched labels may exist. In an optional implementation, each label corresponds to a label identifier (ID). For example, an ID may be assigned to a label when the label is created. Correspondingly, the structured labeling system may further include an ID of a label, in addition to a name of the label.

Based on the foregoing description, attaching matched label(s) to a network object to be labeled at S304 may include attaching label ID(s) of all the matched label(s) to the network object to be labeled. In an implementation, attaching a matched label or a label ID thereof to a network object corresponds to a process of adding a label data field for the network object and writing the matched label or the label ID thereof into the label data field.

Furthermore, it should be noted that, if a network object has been attached with a certain label, this label becomes a part of the data of the network object. Therefore, this label may become a rule for other labels. For example, after a certain network object of a food type is attached with a label of “imported food”, “having a label of imported food” may be acted as a rule when rules are set up for other labels.

In the present embodiment, a network object is attached with a label based on structured label data, and the network object may be searched for based on the label, thus reducing the length and workload of generating a link generated for searching and thereby enhancing the search efficiency.

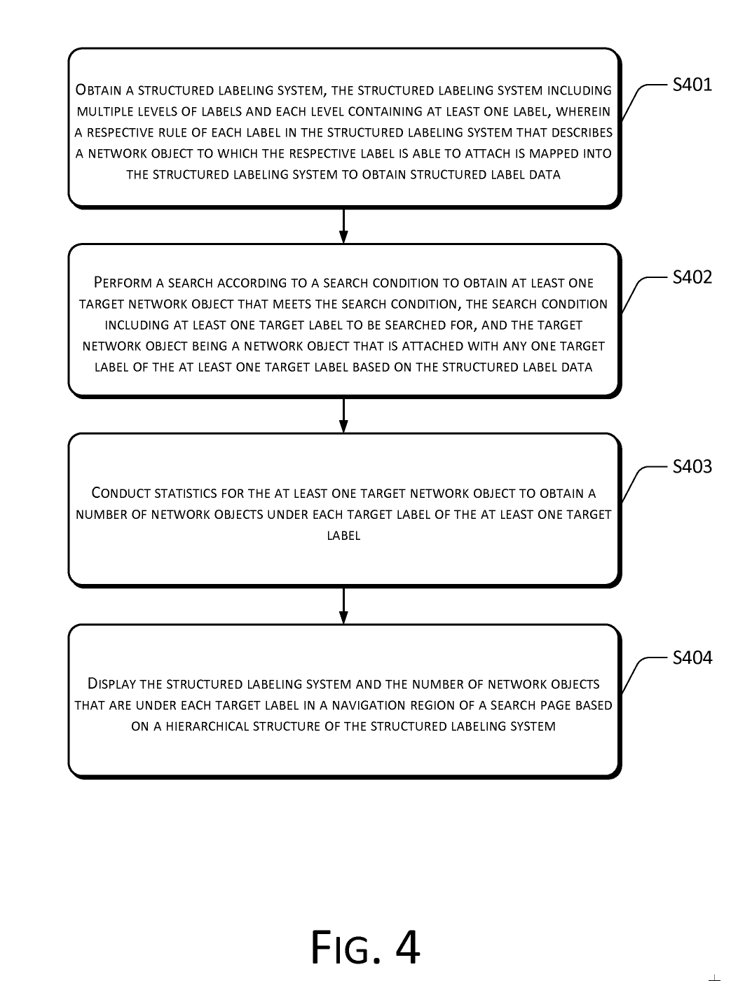

FIG. 4 is a flowchart illustrating a method of using a structured label according to an embodiment of the present disclosure. As shown in FIG. 4, the method may include:

S401 obtains a structured labeling system, the structured labeling system including multiple levels of labels and each level containing at least one label, wherein a respective rule of each label in the structured labeling system that describes a network object to which the respective label is able to attach is mapped into the structured labeling system to obtain structured label data.

An execution entity of this embodiment may be a structured label usage apparatus, referred to as a usage apparatus. The usage apparatus may include a search engine or a search client, for example.

In an optional implementation, the structured labeling system in this embodiment may be created using the embodiment as shown in FIG. 1 or FIG. 3, i.e., created by a structured label generating apparatus. Specifically, the usage apparatus may obtain a structured labeling system from the structured label generating apparatus.

S402 performs a search according to a search condition to obtain at least one target network object that meets the search condition, the search condition including at least one target label to be searched for, and the target network object being a network object that is attached with any one target label of the at least one target label based on the structured label data.

S403 conducts statistics for the at least one target network object to obtain a number of network objects under each target label of the at least one target label.

The structured label data in this embodiment may be obtained by mapping the respective rule of each label for describing the network object to which the respective label is able to attach into the structured labeling system. For example, reference may be made to the description of the embodiment as shown in FIG. 1 or FIG. 3 for a process of obtaining structured label data from a structured labeling system. In an implementation, different labels may have different rules.

After network object(s) is/are attached with respective label(s) based on structured label data, the usage apparatus may search a network object according to a search condition to obtain at least one target network object. The target network object corresponds to a network object that meets the search condition. Since the search condition includes at least one target label that is to be searched for, the target network object is actually a network object that is attached with any one target label of the at least one target label based on the structured label data. Thereafter, a search apparatus counts a number of network objects that are under each target label. In an implementation, the usage apparatus conducts statistics on the at least one target network object to obtain a number of network objects that are under each target label. Target network objects attached with labels of a same level may belong to a same category, or may belong to different categories. In an optional implementation, at least a portion of target network objects that are attached with labels of a same level belong to different categories.

It should be noted that the current search condition may include only one sub-condition, namely the target label, and may include other sub-conditions, such as a price, in addition to or in alternative to the target label. The more sub-conditions the search condition includes, the fewer the target network objects that are found are.

S404 displays the structured labeling system and the number of network objects that are under each target label in a navigation region of a search page based on a hierarchical structure of the structured labeling system.

After the structured labeling system and the number of network objects that are under each target label are obtained, the usage apparatus displays the structured labeling system and the number of network objects that are under each target label in a navigation region of a search page based on a hierarchical structure of the structured labeling system, to provide navigation information for the topical search.

This embodiment performs a search according to a search condition to obtain target network object(s) that meet(s) the search condition, conducts statistics for a respective number of network objects under target label(s) included in the search condition, and displays the structured labeling system and the respective number of network objects under each target label in a navigation region of a search page according to a hierarchical structure of the structured labeling system, to provide navigation information. Since a label, rather than a single category rule, is used in the present disclosure, an inclusion relationship between cluster ranges to which network objects belong can be embodied via a hierarchical relationship between labels, and is no longer embodied by a single category. Moreover, network object(s) corresponding to each label can be determined by different rules. Therefore, network objects attached with labels of a same level may belong to different categories, which is different from the single category rule, thus being applicable to a topical search for network objects covering a plurality of categories and thereby providing navigation information for the topical search in a search page.

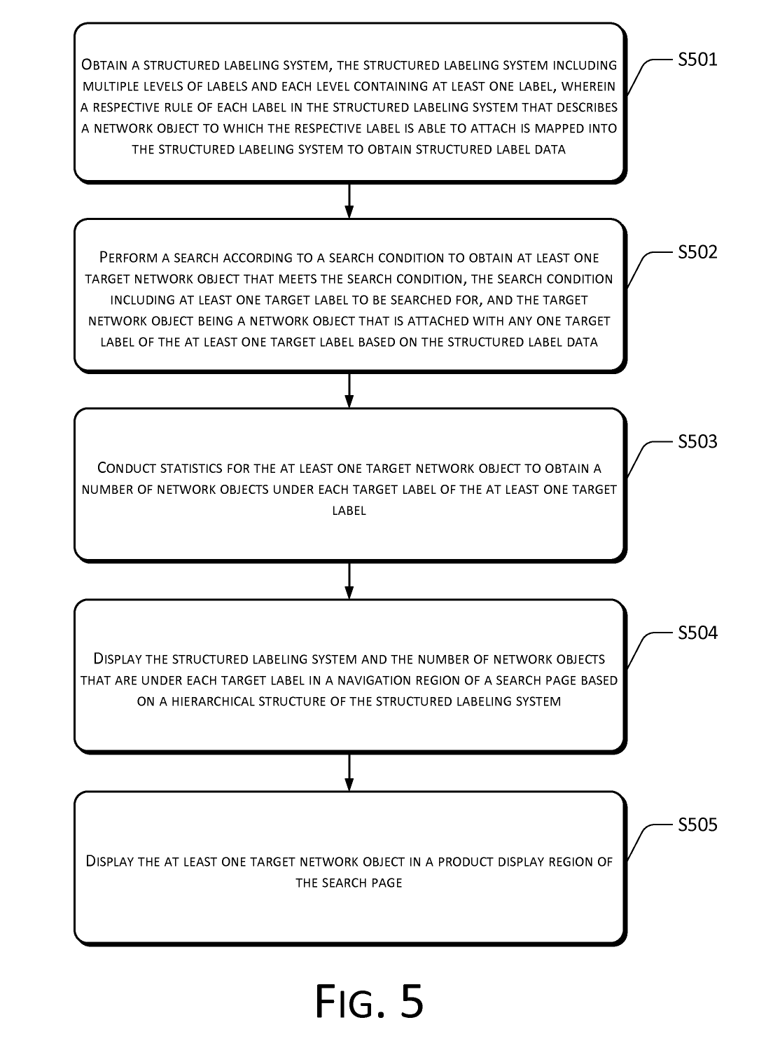

FIG. 5 is a flowchart illustrating a method of using a structured label according to another embodiment of the present disclosure. As shown in FIG. 5, the method may include:

S501 obtains a structured labeling system, the structured labeling system including multiple levels of labels and each level containing at least one label, wherein a respective rule of each label in the structured labeling system that describes a network object to which the respective label is able to attach is mapped into the structured labeling system to obtain structured label data.

S502 performs a search according to a search condition to obtain at least one target network object that meets the search condition, the search condition including at least one target label to be searched for, and the target network object being a network object that is attached with any one target label of the at least one target label based on the structured label data.

S503 conducts statistics for the at least one target network object to obtain a number of network objects under each target label of the at least one target label.

S504 displays the structured labeling system and the number of network objects that are under each target label in a navigation region of a search page based on a hierarchical structure of the structured labeling system.

S505 displays the at least one target network object in a product display region of the search page.

A search page in this embodiment further includes a product display region in addition to a navigation region. Therefore, in addition to displaying navigation information in the navigation region, a corresponding network object is displayed in the product display region.

In an implementation, if a user does not select any label in the structured labeling system that is displayed within the navigation region of the search page, which is equivalent to sending no search request, the usage apparatus may perform a search using the first-level label by default. Specifically, the target label included in the search condition is the first-level label, and network object(s) that is/are found based on the first-level label is/are displayed correspondingly in the product display region. If the user selects a certain label in the structured labeling system displayed in the navigation region of the search page, which is equivalent to sending a search request, the label selected by the user is the target label in the search condition. The usage apparatus may perform a search based on that target label, and display network object(s) that is/are found based on that target label in the product display region.

A process of obtaining a target network object that meets a search condition by the usage apparatus according to a search condition includes the usage apparatus providing the search condition to a backend server, and the backend server performing a search in a network object database to obtain a target network object that meets the search condition, and providing the obtained target network object to the usage apparatus.

This embodiment performs a search according to a search condition to obtain target network objects that meets the search condition, conducts statistics on the target network objects to obtain a number of network objects that are under each target label, and displays a structured labeling system and the number of network objects under each target label in a navigation region of a search page according to a hierarchical structure of the structured labeling system, to provide navigation information. The obtained network objects that are attached with labels of a same level may belong to a same category, or may belong to different categories. In an optional implementation, at least a portion of target network objects that are attached with labels of a same level belong to different categories.

Since a label, rather than a single category rule, is used in the present disclosure, an inclusion relationship between cluster ranges to which network objects belong can be embodied via a hierarchical relationship between labels, and is no longer embodied by a single category. Moreover, network object(s) corresponding to each label can be determined by different rules. Therefore, network objects attached with labels of a same level may belong to different categories, which is different from the single category rule, thus being applicable to a topical search for network objects covering a plurality of categories and thereby providing navigation information for the topical search in a search page.

It should be noted that each foregoing method embodiment is expressed as a sequence of a combination of actions for the sake of description. However, one skilled in the art should understand that the present disclosure is not limited by the described sequence of actions, because some method blocks may be executed in other orders or in parallel according to the present disclosure. Furthermore, one skilled in the art should also understand that the embodiments described in the specification all belong to exemplary embodiments. The actions and modules that are involved may not be necessary for the present disclosure.

In the foregoing embodiments, emphases have been put differently in the description of various embodiments. A portion that is not described in detail in a certain embodiment may be referenced to relevant description of other embodiments.

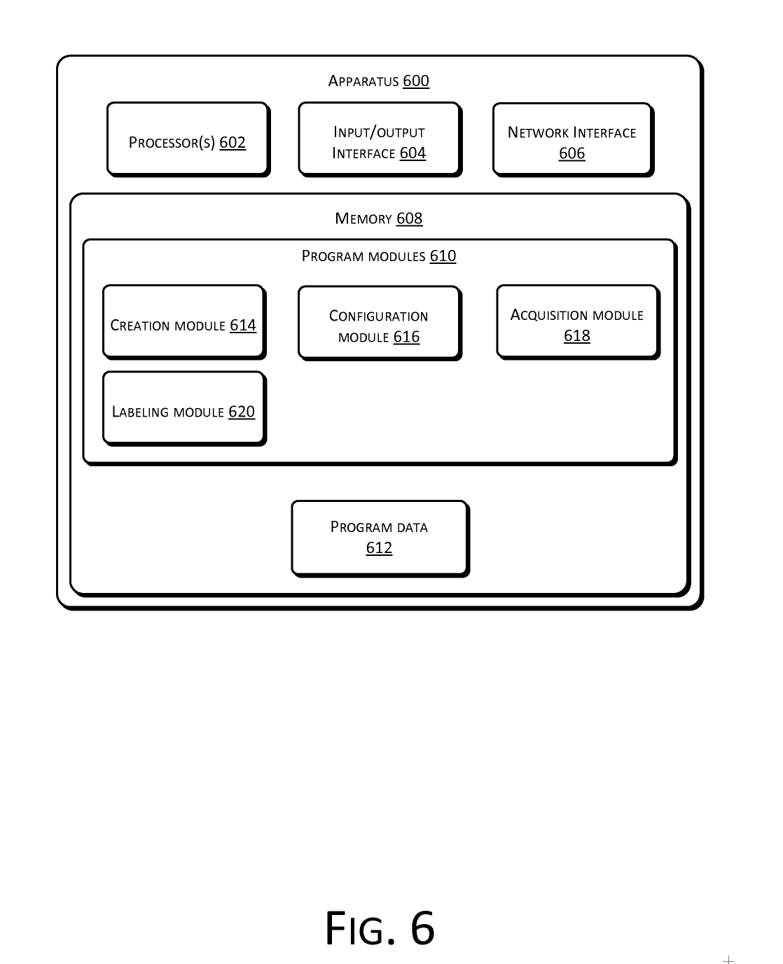

FIG. 6 is a structural diagram illustrating a structured label generating apparatus 600 according to an embodiment of the present disclosure. The apparatus 600 may include one or more computing devices. In an implementation, the apparatus 600 may include one or more processors 602, an input/output (I/O) interface 604, a network interface 606 and memory 608 as shown in FIG. 6.

The memory 608 may include a form of computer readable media such as volatile memory, Random Access Memory (RAM), and/or non-volatile memory, e.g., Read-Only Memory (ROM) or flash RAM, etc. The memory 608 is an example of a computer readable media.

The computer readable media may include a permanent or non-permanent type, a removable or non-removable media, which may achieve storage of information using any method or technology. The information may include a computer-readable command, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In an implementation, the memory 608 may include program modules 610 and program data 612. The program modules 610 may include a creation module 614, a configuration module 616 and an acquisition module 618. The creation module 614 is configured to create a structured labeling system that complies with requirements of a topical search, where the structured labeling system includes multiple levels of labels, and each level containing at least one label. The configuration module 616, which is connected with the creation module 614, is configured to configure, for each label in the structured labeling system created by the creation module 614, at least one rule for describing a network object to which a respective label is able to attach based on data associated with network objects related to the topical search. The acquisition module 618, which is connected with the configuration module 616, is configured to map the rule of each label configured by the configuration module 616 into the structured labeling system to obtain structured label data for use in labeling the network objects related to the topical search. In an implementation, network objects attached with labels of a same level may belong to the same category or may belong to different categories. In an optional implementation, at least a portion of the network objects attached with the labels of the same level belong to different categories.

Furthermore, in an implementation, the apparatus 600 may further include a labeling module 620. The labeling module 620, which is connected with the acquisition module 618, is configured to use data of network object(s) to be labeled to perform matching in the structured label data that is obtained by the acquisition module 618 one level by one level, and attach all matched labels to the network object(s) to be labeled.

In an optional implementation, each label corresponds to a label ID. In an implementation, the labeling module 620 may further be configured to use the data of the network object(s) to be labeled to perform the matching in the structured label data that is obtained by the acquisition module 618 one level by one level, and attach label IDs of all the matched labels to the network object(s) to be labeled.

The structured label generating apparatus 600 that is provided in this embodiment creates a structured labeling system based on requirements of a topical search, configures at least one rule for describing a network object to which a respective label is able to attach for each label under each level in the structured labeling system, maps the rule configured for each label into the structured labeling system correspondingly to obtain structured label data for use in labeling network objects related to the topical search. Since a label, rather than a single category rule, is used in the present disclosure, an inclusion relationship between cluster ranges to which network objects belong can be embodied via a hierarchical relationship between labels, and is no longer embodied by a single category. Moreover, network object(s) corresponding to each label can be determined by different rules. Therefore, network objects attached with labels of a same level may belong to different categories, which is different from the single category rule, thus being applicable to a topical search for network objects covering a plurality of categories and thereby providing navigation information for the topical search in a search page.

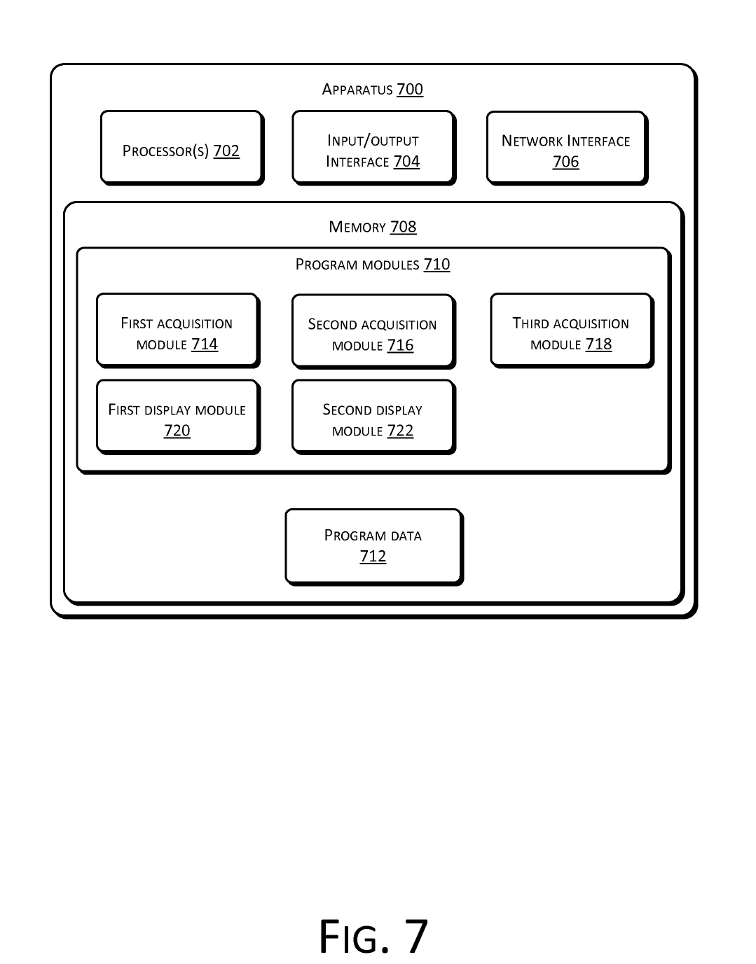

FIG. 7 is a structural diagram illustrating a structured label usage apparatus 700 according to an embodiment of the present disclosure. The apparatus 700 may include one or more computing devices. In an implementation, the apparatus 700 may include one or more processors 702, an input/output (I/O) interface 704, a network interface 706 and memory 708 as shown in FIG. 7. The memory 708 is an example of a computer readable media as described in the foregoing description.

In an implementation, the memory 708 may include program modules 710 and program data 712. In an implementation, the program modules 710 may include a first acquisition module 714, a second acquisition module 716, a third acquisition module 718, and a first display module 720.

The first acquisition module 714 is configured to obtain a structured labeling system, the structured labeling system including multiple levels of labels and each level containing at least one label, wherein a respective rule of each label in the structured labeling system that describes a network object to which the respective label is able to attach is mapped into the structured labeling system to obtain structured label data.

The second acquisition module 716 is configured to perform a search according to a search condition to obtain at least one target network object that meets the search condition, the search condition including at least one target label to be searched for and the target network object being a network object that is attached with any one target label of the at least one target label based on the structured label data. In an implementation, target network objects attached with labels of a same level may belong to a same category or may belong to different categories. In an optional implementation, at least a portion of the target network objects attached with the labels of the same level belong to different categories.

The third acquisition module 718, which is connected with the second acquisition module 716, is configured to conduct statistics on the at least one target network object obtained by the second acquisition module 716 to obtain a number of network objects that are under each target label of the at least one target label.

The first display module 720, which is connected with the first acquisition module 714 and the third acquisition module 718, is configured to display the structured labeling system obtained by the first acquisition module 714 and the number of network objects that are under each target label obtained by the third acquisition module 718 in a navigation region of a search page according to a hierarchical structure of the structured labeling system.

Furthermore, in an implementation, the apparatus 700 may further include a second display module 722.

The second display module 722, which is connected with the second acquisition module 716, is configured to display the at least one target network object obtained by the second acquisition module 716 in a product display region of the search page.

The structured label usage apparatus 700 provided in this embodiment performs a search according to a search condition to obtain target network object(s) that meet(s) the search condition, conducts statistics for a respective number of network objects under target label(s) included in the search condition, and displays the structured labeling system and the respective number of network objects under each target label in a navigation region of a search page according to a hierarchical structure of the structured labeling system, to provide navigation information. Since a label, rather than a single category rule, is used, an inclusion relationship between cluster ranges to which network objects belong can be embodied via a hierarchical relationship between labels, and is no longer embodied by a single category. Moreover, network object(s) corresponding to each label can be determined by different rules. Therefore, network objects attached with labels of a same level may belong to different categories, which is different from the single category rule. Therefore, the apparatus 700 provided in this embodiment displays the structure labeling system and the respective number of network objects under each label in the structured labeling system in the navigation region of the search page, thus being applicable to a topical search for network objects that cover a plurality of categories and thereby providing navigation information for the topical search in the search page.

In an implementation, a server is further provided. The server is configured to respond to an access request sent from a user via a client, enable the client to display a topical webpage interface. The topical webpage interface includes a search region, a network object display region, and a structured label display region. The search region is configured to receive a query inputted by the user. The network object display region is configured to display multiple network objects that match with the query. The structured label display region is configured to display at least one first-level label and at least one second-level label that is located under the first-level label. When at least one of the first-level label or the second-level label is selected by the user, a network object set that is displayable in the network object display region includes at least a first network object and a second network object. The first network object belongs to a first category, and the second network object belongs to a second category that is different from the first category.

In an optional implementation, the second-level label is associated with the first network object belonging to the first category and the second network object belonging to the second category through a preset mapping rule.

The server provided in this embodiment allows a client to adopt a label for managing network objects. Different network objects attached with labels of a same level belong to different categories, which is different from a single category rule, thus being applicable to a topical search for network objects covering a plurality of categories and therefore providing navigation information for the topical search in a search page.

One skilled in the art can clearly understand that detailed working processes of the foregoing systems, apparatuses and units may be referenced to corresponding processes in the foregoing method embodiments, and are not repeatedly described herein for the sake of convenience and ease of description.

In the embodiments provided by the present disclosure, it should be understood that the disclosed systems, apparatuses, and methods may be implemented in other manners. For example, the described apparatus embodiment is merely exemplary. For example, the division of units is merely a division of logical functions and other ways of division may exist in real implementations. For example, a plurality of units or components may be combined or integrated into another system, or some features may be ignored or not executed. In addition, the displayed or discussed mutual couplings, direct couplings or communication connections may be implemented through indirect couplings or communication connections between some interfaces, apparatuses or units, and may be implemented in electronic, mechanical, or other forms.

The units that are described as separate components may or may not be physically separate. Components displayed as units may or may not be physical units, and may be located in a single position, or may be distributed among a plurality of network units. Some or all of the units may be selected according to actual needs to achieve the objectives of the solutions of the embodiments.

In addition, functional units in the embodiments of the present disclosure may be integrated as a single processing unit. Alternatively, each of the units may exist as physically independent. Alternatively, two or more units may be integrated as a single unit. The integrated unit may be implemented in a form of hardware, or may be implemented in a form of a software functional unit.

The integrated unit, which is implemented in the form of a software functional unit, may be stored in a computer-readable storage media. The software functional unit is stored in a storage media, and includes instructions to cause a computing device (which may be a personal computer, a server, or a network device, etc.) or a processor to perform some method blocks of the methods described in the embodiments of the present disclosure. The storage media may include various types of media that are able to store program codes, such as a USB flash drive, a removable hard disk, a read-only memory (ROM), a random access memory (RAM), a magnetic disk, or an optical disk, etc.

It should be noted that the embodiments are merely used for describing the technical solutions of the present disclosure and do not impose any limitation thereon. Although a detailed description of the present disclosure is given with reference to the foregoing embodiments, one skilled in the art should understand that modifications may still be made to the technical solutions described in the foregoing embodiments, or equivalent replacements may be performed for some of the technical features thereof. These modifications and replacements do not cause the nature of the corresponding technical solutions to depart from the spirit and scope of the technical solutions of the embodiments of the present disclosure.

What is claimed is:

1. A method implemented by one or more computing devices, the method comprising:
creating a structured labeling system including multiple levels of labels and each level including at least one label, wherein each label is attached to at least one network object;
configuring at least one rule for each label in the structured labeling system, wherein the rule is used to select one or more network objects from a plurality of network objects; and
labeling the plurality of network objects according to the configured rule, wherein at least a portion of the plurality of network objects related to a topical search belong to different categories.

2. The method of claim 1, further comprising performing a matching in structured label data to find one or more matched labels using data of a network object to be labeled.

3. The method of claim 2, further comprising attaching the one or more matched labels to the network object to be labeled.

4. The method of claim 3, further comprising attaching respective one or more label identifiers of the one or more matched labels to the network object to be labeled.

5. The method of claim 2, wherein performing the matching in the structured label data comprises:
traversing one or more rules of a label of a first level of a plurality of levels of the structured label data; and
determining whether the data of the network object to be labeled satisfies the one or more rules of the label of the first level.

6. The method of claim 5, wherein performing the matching in the structured label data further comprises attaching the label of the first level to the network object to be labeled in response to determining that the data of the network object satisfies the one or more rules of the label of the first level.

7. The method of claim 5, wherein performing the matching in the structured label data further comprises:
traversing one or more rules of a label of a second level of the plurality of levels of the structured label data; and
determining whether the data of the network object satisfies the one or more rules of the label of the second level.

8. The method of claim 1, further comprising performing a search according to a search condition to obtain at least one target network object that meets the search condition, the search condition comprising at least one target label to be searched for, and the at least one target network object being an network object attached with any one of the at least one target label based at least in part on the structured label data.

9. The method of claim 8, further comprising:
obtaining a respective number of network objects that are under each target label of the at least one target label; and
displaying the structured labeling system and the respective number of network objects that are under each target label in a navigation region of a search page according to a hierarchical structure of the structured labeling system.

10. The method of claim 9, further comprising displaying the at least one target network object in a product display region of the search page.

11. An apparatus comprising:
one or more processors;
memory;
a first acquisition module stored in the memory and executable by the one or more processors to obtain a structured labeling system including multiple levels of labels and each level including at least one label, wherein at least one rule is configured for each label, and the rule is used to select one or more network objects from a plurality of network objects;
a second acquisition module stored in the memory and executable by the one or more processors to perform a search according to a search condition to obtain a plurality of target network objects that meet the search condition, the search condition including at least one target label to be searched for, and a target network object of the plurality of target network objects being a network object that is attached with any one target label of the at least one target label based at least in part on structured label data;
a third acquisition module stored in the memory and executable by the one or more processors to obtain a respective number of network objects that are under each target label of the at least one target label, wherein at least a portion of multiple target network objects attached with labels belong to different categories; and
a first display module stored in the memory and executable by the one or more processors to display the structured labeling system obtained by the first acquisition module and the respective number of network objects that are under each target label obtained by the third acquisition module in a navigation region of a search page according to a hierarchical structure of the structured labeling system.

12. The apparatus of claim 11, further comprising a second display module to display the at least one target network object in a product display region of the search page.

13. The apparatus of claim 11, wherein at least a portion of the target network objects attached with the labels of the same level belong to different categories.

14. The apparatus of claim 11, further comprising:
a creation module stored in the memory and executable by the one or more processors to create the structured labeling system;
a configuration module stored in the memory and executable by the one or more processors to configure the respective rule of each label in the structured labeling system that describes the network object to which the respective label is able to attach based at least in part on data associated with a plurality of network objects related to a topical search; and
an acquisition module stored in the memory and executable by the one or more processors to map the respective rule of each label configured by the configuration module into the structured labeling system to obtain the structured label data for use in labeling the plurality of network objects related to the topical search.

15. The apparatus of claim 14, further comprising a labeling module to use data of a network object to be labeled to perform matching in the structured label data that is obtained by the acquisition module one level by one level, and attach one or more matched labels to the network object to be labeled.

16. The apparatus of claim 15, wherein each label corresponds to a label identifier, and wherein the labeling module further attaches respective one or more label identifiers of the one or more matched labels to the network object to be labeled.

17. One or more computer-readable media storing executable instructions that, when executed by one or more processors, cause the one or more processors to perform acts comprising:
creating a structured labeling system including multiple levels of labels and each level including at least one label;
configuring at least one rule for each label in the structured labeling system, wherein the rule is used to select one or more network objects from a plurality of network objects; and
labeling the plurality of network objects according to the configured rule, wherein at least a portion of the plurality of network objects related to a topical search belong to different categories.

18. The one or more computer-readable media of claim 17, the acts further comprising performing a matching in the structured label data to find one or more matched labels using data of a network object to be labeled.

19. The one or more computer-readable media of claim 18, the acts further comprising attaching the one or more matched labels to the network object to be labeled.

20. The one or more computer-readable media of claim 19, the acts further comprising attaching respective one or more label identifiers of the one or more matched labels to the network object to be labeled.
